(19) United States
(12) Patent Application Publication
(10) Pub. No.: US 2013/0159929 A1
(43) Pub. Date: Jun. 20, 2013

(54) METHOD AND APPARATUS FOR PROVIDING CONTENTS-RELATED INFORMATION

(71) Applicant: KT Corporation, Seongnam (KR)

(72) Inventors: Hoon-Kyu PARK, Suwon-si (KR); Ju-Yong LEE, Incheon (KR); Jin-Han KIM, Gunpo-si (KR); Se-Jun PARK, Daejeon (KR); Han-Wook JUNG, Seoul (KR)

(73) Assignee: KT CORPORATION, Seongnam (KR)

(21) Appl. No.: 13/722,609

(22) Filed: Dec. 20, 2012

(30) Foreign Application Priority Data
Dec. 20, 2011 (KR) 10-2011-0138279

(51) Int. Cl. G06F 3/0484

(52) U.S. Cl. CPC G06F 3/04842
USPC 715/810

(57) ABSTRACT

A method and an apparatus for providing content-related information. The method includes requesting contents-related information from a contents information management server, receiving at least one contents-related information from the contents information management server, displaying the at least one contents-related information, receiving a user selection of one contents-related information item from among the at least one contents-related information and reproducing contents from a reproduction time corresponding to the selected contents-related information item.

### CROSS-REFERENCE TO RELATED APPLICATION

This application claims the benefit of priority from the Korean Patent Application No. 10-2011-0138279, filed on Dec. 20, 2011 in the Korean Intellectual Property Office, the entire disclosure of which is incorporated herein by reference in its entirety

### BACKGROUND

1. Field

Exemplary embodiments broadly relate to a method and an apparatus for providing contents-related information, and more particularly, to a method and an apparatus for providing a user device with contents-related information.

2. Description of the Related Art

With recent development of technologies, the number of devices used by a user is increasing. Further, it is common that one user uses multiple devices.

Users are often provided with contents, such as, video contents using the devices. Demands for providing additional information about contents together with the contents are increasing.

In order to provide additional information about contents according to the user demands, a technology of registering and providing additional information about contents has been proposed.

With respect to related art, Korean Patent Application Publication No. 2007-0057578 describes adding tag information to an internet resource, and providing the internet resource, to which the tag information has been added, to multiple user devices so as to share the tag information. Korean Patent Application Publication No. 2011-0045935 describes providing an additional service associated with contents being reproduced in an IPTV in response to a request from a user.

However, in order to enable only a contents manager to collect and provide contents-related information, numerous resources are required. Further, contents are necessarily restricted.

### SUMMARY

Accordingly, it is an aspect to provide a method and an apparatus for providing contents-related information upon providing the contents, and furthermore, enabling a user as well as a contents provider to generate and register new contents-related information.

According to an aspect of exemplary embodiments, a method of providing content-related information includes requesting contents-related information from a contents information management server, receiving at least one contents-related information from the contents information management server, displaying the at least one contents-related information, receiving a user selection of one contents-related information item from among the at least one contents-related information and reproducing contents from a reproduction time corresponding to the selected contents-related information item.

According to another aspect of exemplary embodiments, there is provided a method of transmitting contents-related information. The method includes receiving a request, from a user device, for providing the contents-related information which is information related to contents being reproduced by the user device, transmitting, in response to the request, at least one contents-related information to the user device, receiving a signal for selecting one contents-related information item from among the at least one contents-related information and transmitting, to a service providing server, reproduction time information corresponding to the selected contents-related information item, wherein reproduction time information for reproducing the contents by the user device from a time point indicated by the reproduction time information, is provided from the service providing server and is obtained based on the transmitted reproduction time information.

According to yet another aspect of exemplary embodiments, a contents information management apparatus includes a request receiver configured to receive a request from a user device for providing contents-related information which is information related to contents being reproduced by the user device, an information transmitter configured to transmit to the user device, in response to the request, at least one contents-related information and a signal receiver configured to receive a signal for selecting one contents-related information item from among the at least one contents-related information, wherein the information transmitter is further configured to transmit reproduction time information corresponding to the selected contents-related information to a service providing server, and wherein reproduction time information for reproducing the contents by the user device from a time point indicated by the reproduction time information, is provided from the service providing server and is obtained based on the transmitted reproduction time information.

In exemplary embodiments, it is possible to provide contents-related information upon providing the contents. Furthermore, a user using the contents as well as a contents provider can generate and register new contents-related information. Thus, more contents-related information can be generated without consuming many resources.

A separate, independent entity such as contents information management server, and not a service provider of each device, provides the contents-related information to the user device. Thus, the user device can be provided with contents-related information, irrespective of a service providing server.

### BRIEF DESCRIPTION OF THE DRAWINGS

Non-limiting and non-exhaustive exemplary embodiments will be described in conjunction with the accompanying drawings. Understanding that these drawings depict only exemplary embodiments and are, therefore, not intended to limit its scope, the exemplary embodiments will be described with specificity and detail taken in conjunction with the accompanying drawings, in which:

FIG. 1 is a view illustrating a configuration of a contents-related information providing system according to an exemplary embodiment;

FIG. 2 is a flow chart illustrating a contents-related information providing method according to an exemplary embodiment;

FIG. 3 is a flow chart illustrating a scene information generating method according to an exemplary embodiment;

FIG. 4 is a flow chart illustrating a contents-related information generating method according to an exemplary embodiment;

FIG. 5 is a flow diagram illustrating a contents-related information providing method according to another exemplary embodiment;

FIG. 6 is a flow chart illustrating a scene preferences generating method according to an exemplary embodiment;

FIG. 7 is a block diagram illustrating a contents information management apparatus according to an exemplary embodiment;

FIG. 8 is a view illustrating a reproduction screen displaying contents-related information according to an exemplary embodiment; and

FIG. 9 is a view illustrating a reproduction screen displaying contents-related information according to another exemplary embodiment;

### DETAILED DESCRIPTION OF EXEMPLARY EMBODIMENTS

Hereinafter, exemplary embodiments will be described in detail with reference to the accompanying drawings to be readily implemented by those skilled in the art. However, it is to be noted that the present disclosure is not limited to the exemplary embodiments, but can be realized in various other ways. In the drawings, certain parts not directly relevant to the description of exemplary embodiments are omitted to enhance the clarity of the drawings, and like reference numerals denote analogous parts throughout the whole document.

Throughout the whole document, the terms “connected to” or “coupled to” are used to designate a connection or coupling of one element to another element, and include both a case where an element is “directly connected or coupled to” another element and a case where an element is “electronically connected or coupled to” another element via still another element. Further, each of the terms “comprises,” “includes,” “comprising,” and “including,” as used in the present disclosure, is defined such that one or more other components, steps, operations, and/or the existence or addition of elements are not excluded in addition to the described components, steps, operations and/or elements.

Hereinafter, exemplary embodiments will be explained in detail with reference to the accompanying drawings.

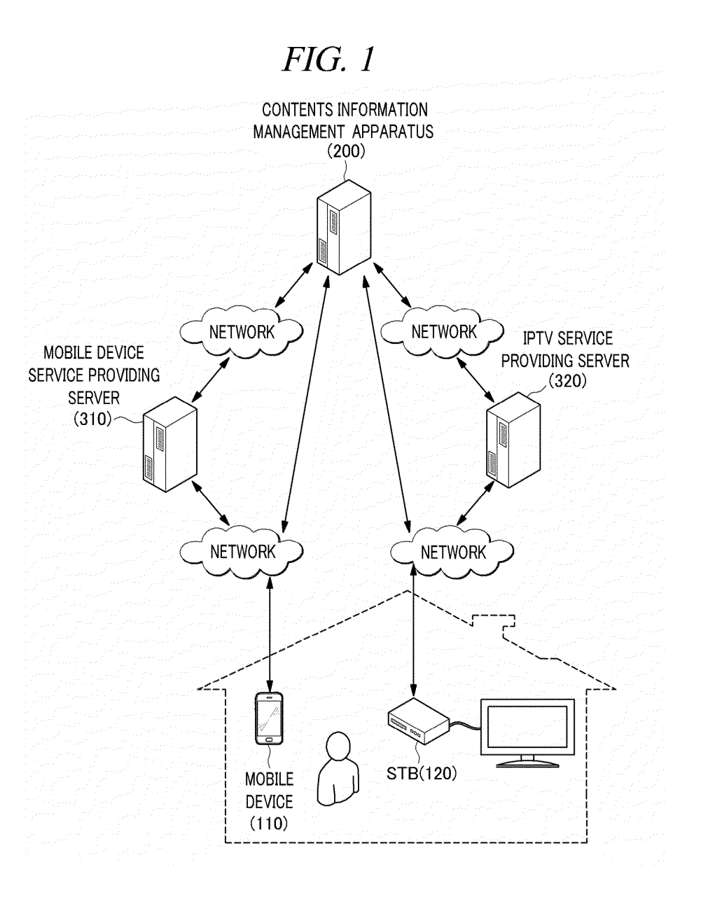

FIG. 1 is a view illustrating a configuration of a contents-related information providing system according to an exemplary embodiment.

According to an exemplary embodiment, a mobile device 110 or a set-top box (STB) 120 requests contents-related information associated with contents being currently reproduced or to be reproduced by the mobile device 110 or the set-top box (STB) 120 to a contents information management apparatus 200 through a contents providing application provided in the mobile device 110 or the set-top box 120. In an exemplary embodiment, the mobile device 110 and the STB 120 may include at least a processor and a memory. According to an exemplary embodiment, the mobile device 110 may further include a user interface, a display screen, and a communicator to communicate in a wireless network.

The mobile device 110 or the set-top box 120 may receive contents from a mobile device service providing server 310 or an IPTV service providing server 320 and reproduce the contents. Otherwise, the mobile device 110 or the set-top box 120 may receive contents from the contents information management apparatus 200 and reproduce the contents. In an exemplary embodiment, the mobile device service providing server 310, the IPTV service providing server 320 and the contents information management apparatus 200 may include a processor, a memory, and one or more communicators to communicate in a wireless and/or wired network. Although a single server/apparatus is shown in an exemplary embodiment, one of ordinary skill in the art would readily appreciate that a number of servers/apparatuses may be provided.

In response to the request received from the mobile device 110 or the set-top box 120 for the contents-related information, the contents information management apparatus 200 transmits contents-related information to the mobile device 110 or to the set-top box 120.

The contents information management apparatus 200 may provide at least one contents-related information item matched with identification information of the contents to the mobile device 110 or the set-top box 120 by using the identification information of the contents received from the mobile device 110 or the set-top box 120.

Each contents-related information item provided by the contents information management apparatus 200 may be matched with respective reproduction time information of the contents. Accordingly, the mobile device 110 or the set-top box 120, which has received the contents-related information, may display an indicator which indicates presence of contents-related information matched with present reproduction time information during reproduction of the contents.

In case of receiving the contents-related information prior to reproduction of the contents, the mobile device 110 or the set-top box 120 may indicate, in advance, the contents-related information matched with the contents to be reproduced.

If a user selects certain contents-related information, the mobile device 110 or the set-top box 120 may move a time identifier to a reproduction time matched with the selected contents-related information and reproduce the contents from the corresponding reproduction time to provide the contents to the user.

The mobile device 110 or the set-top box 120 may match scene information input from the user during reproduction of the contents with a respective reproduction time, to transmit the scene information to the contents information management apparatus 200.

The contents information management apparatus 200 registers and manages the scene information received from the mobile device 110 or the set-top box 120 as tag information of the contents. The scene information registered and managed by the contents information management apparatus 200 as the tag information may be set separately as contents-related information, and thereafter, provided to a user device when a request for the contents-related information from the user is made.

If the mobile device 110 requests that the contents is to be reproduced in the set-top box 120 from a reproduction time matched with the contents-related information, the contents information management apparatus 200 may request the reproduction of the corresponding contents to the IPTV service providing server 320 so that the corresponding contents can be displayed using the set-top box 120 from a reproduction time matched with the contents-related information.

Further, the contents information management apparatus 200 may collect a signal for selecting contents-related information among the at least one contents-related information and reproduction time information of the selected contents-related information received from the mobile device 110 or the set-top box 120, and generate scene preferences about the contents based on the collected number of signals.

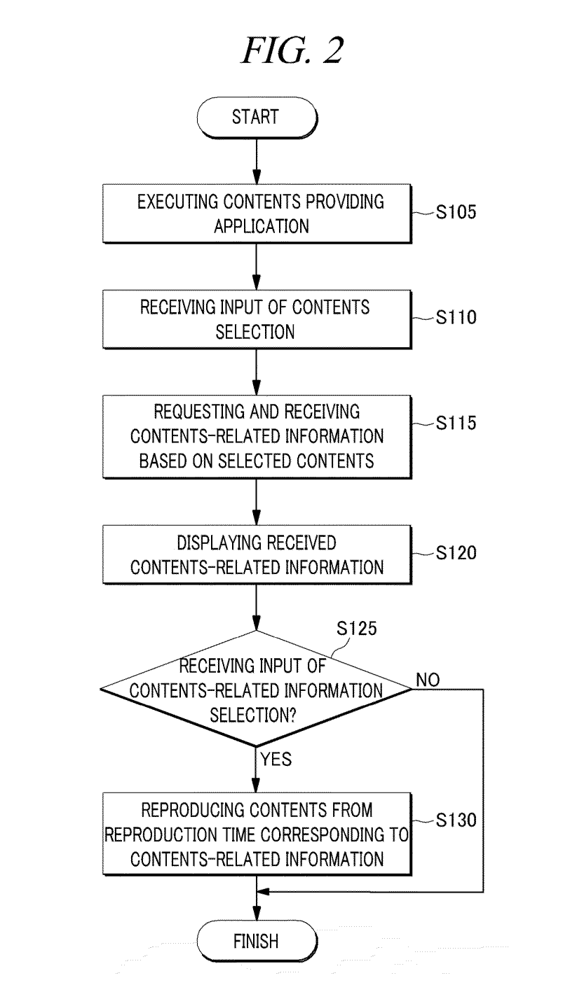

FIG. 2 is a flow chart illustrating a contents-related information providing method according to an exemplary embodiment.

In operation S105, a user device executes a contents providing application provided in the user device. The user device may include wired communication devices such as a set-top box as well as mobile devices such as a smart phone and a tablet PC.

In operation S110, the user device receives a user input in which one contents from among multiple contents provided through the contents providing application is selected. That is, the user can select one contents from among multiple contents included in a contents list provided using the contents providing application of the user device.

In operation S115, the user device transmits identification information of the selected contents to the contents information management server (not illustrated), requests contents-related information associated with the selected contents from the contents information management server, and receives at least one contents-related information from the contents information management server.

In operation S120, the user device displays the received contents-related information to provide the information to the user. The at least one contents-related information may include brief descriptions of each information and reproduction time information of the contents corresponding to the contents-related information.

The contents-related information may include information about a time when the contents-related information is generated, scene location information, such as an address, of a site displayed in a scene corresponding to the contents-related information, location information, such as latitude and longitude information or global positioning system (GPS) information, of a position where the contents-related information is generated, thumbnail information of the contents-related information, and preference information of the contents. In an exemplary embodiment, the contents-related information may be metadata which provides additional information about an element depicted in contents. For example, if an element is a person, additional information may be actor's name, date of birth, other movies the actor played in and so on. If an element is a building, for example, additional information may provide historic information for the building (i.e., when it was build, who is the architect, when it was remodeled, and so on) in addition to providing address or location information for the building and maybe businesses that occupy the building. The contents-related information may be an advertisement of the product shown in the contents. In an exemplary embodiment, the content related information may be custom information provided by the user e.g., “this is a good hangout place.” The contents-related information may be provided in a form of at least one of an image, text, a video clip, a thumbnail, a web site, and so on.

In operation S125, the user device determines whether user input indicating a selection of the displayed contents-related information. That is, the user can select the contents-related information displayed in operation S120 using the user device. The user device determines whether the user selected one or more items of the displayed contents-related information.

Multiple contents-related information items may be displayed in operation S120. The multiple contents-related information may be provided in a form of a list, and each contents-related information item may include brief descriptions of each information and reproduction time information of the contents corresponding to the contents-related information item. The user may select one of the displayed multiple contents-related information items. The contents-related information may be displayed using an contents-related information layer. The contents-related information layer may be overlaid with information previously output to the user device, e.g., a reproduction screen of the contents.

In operation S130, if it is determined in operation S125 that user input of selecting the contents-related information item has been received, the user device reproduces the contents selected in operation S110 from a reproduction time corresponding to the contents-related information selected in operation S125.

While reproducing the contents from a reproduction time corresponding to the selected contents-related information, the user device may display the selected contents-related information to provide the information to the user.

In the above exemplary descriptions, after the contents are selected, the contents-related information is displayed, and once the displayed contents-related information is selected, the contents are reproduced. However, the exemplary embodiment is not limited thereto. When the user makes a request for providing contents-related information during the reproduction of the contents, the user device may receive the contents-related information from the contents information management server to provide the information, and once the user selects the provided contents-related information, the contents may be reproduced from a reproduction time corresponding to the selected contents-related information.

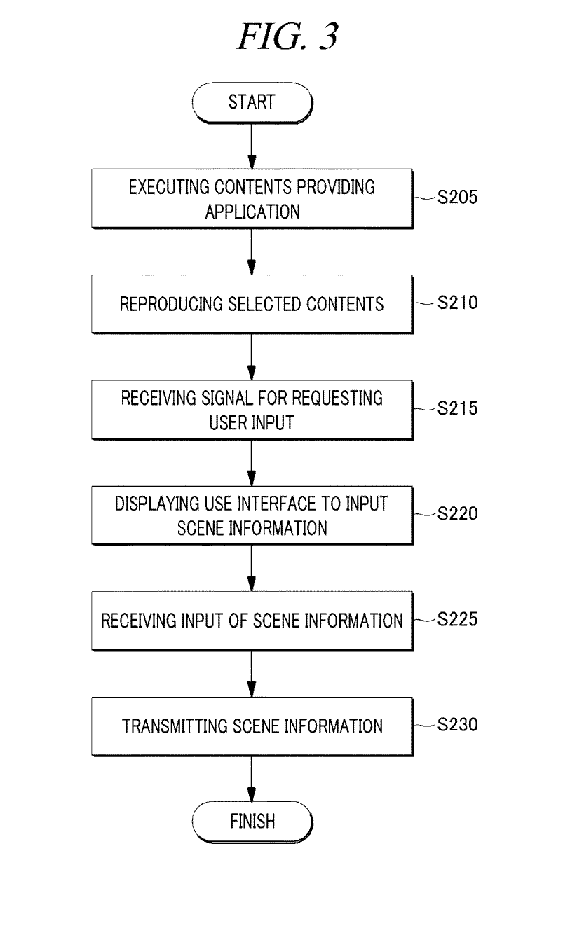

FIG. 3 is a flow chart illustrating a scene information generating method according to an exemplary embodiment.

In operation S205, the user device executes a contents providing application provided in the user device.

In operation S210, the user device reproduces the contents selected by the user. The user device may reproduce contents provided by the contents information management server, or a service providing server to the user device, e.g., a mobile device service providing server if the user device to reproduce the contents is a mobile device.

The user device may acquire identification information of the contents to be reproduced.

In operation S215, the user device receives a signal for requesting a user interface to receive an input of scene information from the user, during reproduction of the contents selected in operation S210. That is, if the user wants to input scene information such as a tag in a certain scene while watching the contents, the user may input a tag into the user device.

If the user is provided with contents by using a mobile device which enables input in a touch manner, the user may input the tag by using a touch user interface at a reproduction time where the scene information is to be generated.

In operation S220, in response to the request signal received in operation S215, the user device displays the user interface such as a scene information input layer enabling input of the scene information to a display apparatus connected to the user device.

The user device may display the scene information input layer overlaid on a reproduction screen of the contents. Further, the scene information input layer may be displayed in a semi-transparent state.

In operation S225, the user device receives, from the user, an input of scene information using the scene information input layer displayed in operation S220. The scene information input layer displayed in operation S220 includes a user interface that enables the user to input scene information. The user may input scene information by using the scene information input layer.

The user may input scene location information, e.g., address information, of a site displayed in a scene being currently reproduced in the contents. If a certain restaurant appears in the reproduction screen, the user may select a location of the corresponding restaurant on a map provided together with the scene information input layer to input scene location information of the corresponding restaurant. The location selected by the user may be converted into address information by the user device.

While receiving the scene information from the user, the user device may acquire location information based on the depicted scene at the time when the user input occurs. That is, while providing the scene information input layer to the user, the user device may acquire current location information, e.g., latitude and longitude information, or GPS information, of the user device.

The user device may receive additional information corresponding to the scene such as thumbnail information from the user.

In operation S230, the user device transmits the scene information input in operation S225 to the contents information management server. The user device may transmit information about the contents being currently reproduced, e.g., identification information of the contents and reproduction time information of the input scene information to the contents information management server together with the input scene information. The user device may transmit the scene location information and the location information acquired in operation S225 to the contents management server together with the scene information input by the user.

As described above, according to an exemplary embodiment, the user may input his/her opinion or information that he/she wants to share in a certain scene while viewing contents using the user device, and may transmit the input opinion or information to the contents information management server to register the information for the corresponding contents.

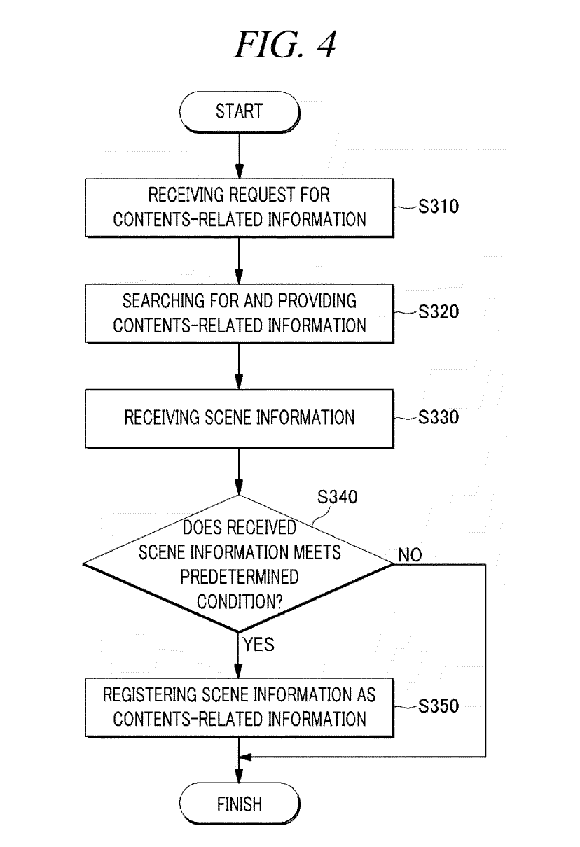

FIG. 4 is a flow chart illustrating a contents-related information generating method according to an exemplary embodiment.

In operation S310, the contents information management server receives a request for contents-related information from the user device. Further, the contents information management server may receive identification information of the contents and reproduction time information corresponding to the requested contents-related information together with the request for the contents-related information.

In operation S320, the contents information management server searches for the contents-related information corresponding to the reproduction time information received in operation S310 by using the identification information of the contents and the reproduction time information that have been received in operation S310, and provides the found contents-related information to the user device.

In operation S330, the contents information management server receives scene information input by the user using the user device. The contents information management server may receive, from the user device, identification information of the contents and reproduction time information when the user requests a user interface to input the scene information, together with the input scene information.

As aforementioned, the scene information may include scene location information, e.g., address information, of a place appearing in scene.

The contents information management server may receive, from the user device, reproduction time information when the scene related information is generated, location information, such as latitude and longitude information or GPS information, of a position where the scene information is generated, and thumbnail information of the scene information.

In operation S340, the contents information management server determines whether to register the scene information received in operation S330 as contents-related information by determining whether the received scene information meets a predetermined condition. Since there may be scene information with low credibility and scene information with high credibility among the scene information input by the user, the contents information management server may evaluate the credibility of the corresponding scene information to determine whether to register the scene information as contents-related information associated with the corresponding contents. In an exemplary embodiment, a criteria used to determine credibility of the custom content-related information may be determining if such information is found on the internet. For example, the custom content-related information may be searched for on the Internet and if at least one search result confirms the custom content-related information input by the user, new content-related information is generated.

In operation S350, if it is determined that the received scene information meets a predetermined condition, the contents information management server registers the scene information received in operation S330 as contents-related information by matching the scene information with the identification information of the contents and the reproduction time information of the contents that have been received in operation S330.

Thereafter, when the same user or another user makes a request for contents-related information, the information registered as contents-related information may be provided to the user as contents-related information.

In particular, the user may be provided with scene location information, e.g., address information, of a place appearing in the scene. The user may also be provided with time information, location information, and others with regard to the generating of the contents-related information. Based on the scene location information, a location related service may be provided. For example, when the contents information management apparatus receives, from the user device, location information, the contents information management apparatus may transmit, to the user device, contents-related information corresponding the location information.

As described above, the contents-related information includes location information of a position where the contents-related information is generated. Thus, based on current location information of the user device, the contents information management server may search contents-related information, in which information associated with a position within a certain radius from the current position of the user device exists, e.g., contents, in which a place associated with the corresponding position appears, to provide the contents corresponding to the searched contents-related information or the searched contents-related information to the user device. In particularly, the contents can be provided from a reproduction time corresponding to the found contents-related information in association with the corresponding position, i.e., a scene, in which a place associated with the corresponding position appears.

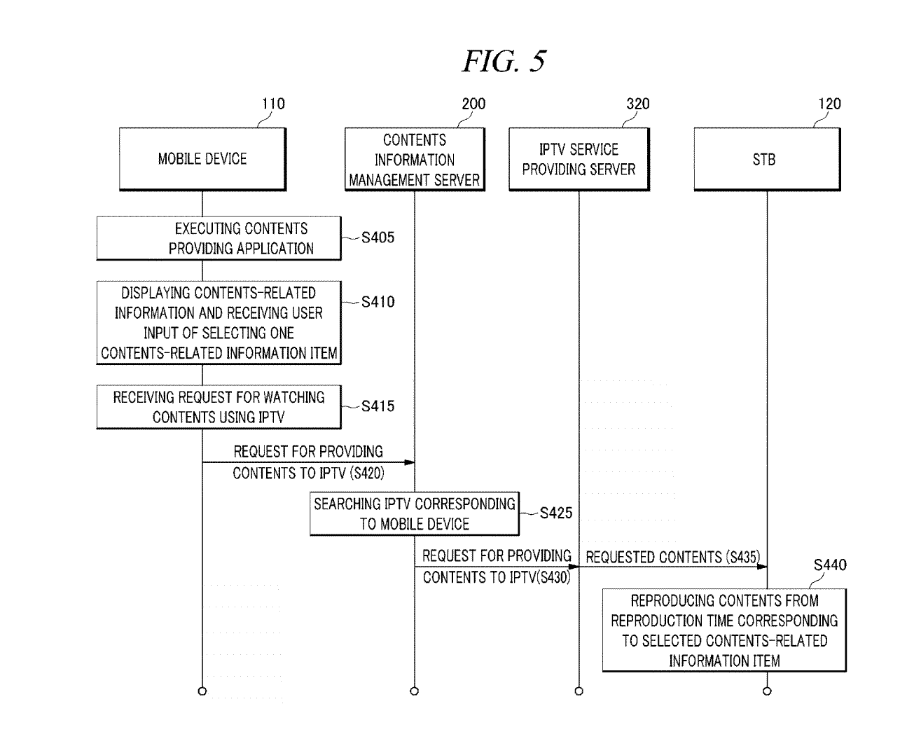

FIG. 5 is a flow diagram illustrating a contents-related information providing method according to another exemplary embodiment.

In operation S405, the mobile device 110 executes a contents providing application in the mobile device 110. Further, the mobile device 110 requests content related information for the contents reproduced on a mobile device and the content-related information requested from the content information management apparatus are provided to the mobile device in response to the request.

In operation S410, the mobile device 110 displays at least one contents-related information received from the contents information management apparatus 200, and receives user input indicating a selection of one contents-related information item.

In operation S415, the mobile device 110 receives user input indicating a request that the contents be reproduced from a reproduction time that matches with the selected contents-related information item and that requests that the contents be reproduced using an IPTV interworked with one of the user devices and not necessarily using the mobile device 110.

If user input for selecting contents-related information item is received in operation S410, the mobile device 110 may display a message to confirm whether the mobile device 110 will reproduce the corresponding contents, or whether another device interworked with the user of the mobile device 110 should reproduce the corresponding contents.

The user may confirm the request that the corresponding contents be displayed using an IPTV provided by the set-top box 120, and not using the mobile device 110.

In operation S420, the mobile device 110 requests that the contents information management apparatus 200 provides contents corresponding to the selected contents-related information item to the set-top box 120. The mobile device 110 may transmit information about the set-top box 120 e.g., identification information of the set-top box 120, to the contents information management apparatus 200, in addition to the information about the contents and the reproduction time information corresponding to the selected contents-related information item.

In operation S425, the contents information management apparatus 200 searches information of an IPTV corresponding to the mobile device 110, i.e., the set-top box 120. The contents information management apparatus 200 may acquire information, such as an address, of the IPTV service providing server 320 for providing contents to the set-top box 120 by using the information of the mobile device 110 or the information of the set-top box 120.

In operation S430, the contents information management apparatus 200 requests that the IPTV service providing server 320 provide the contents to the set-top box 120, by using the acquired information, such as an address, of the IPTV service providing server 320.

The contents information management apparatus 200 may transmit, to the IPTV service providing server 320, information about the set-top box 120, the identification information of the contents requested to be provided, and the reproduction time information corresponding to the selected contents-related information, together with a request for providing the contents.

In operation S435, in response to the request for providing the contents received from the contents information management apparatus 200 in operation S430, the IPTV service providing server 320 provides the requested contents to the set-top box 120. The IPTV service providing server 320 may provide the reproduction time information to the set-top box 120 together with the requested contents.

In operation S440, the set-top box 120 reproduces the contents provided in operation S435, i.e., the contents corresponding to the contents-related information item selected by the mobile device 110 in operation S410, from a reproduction time corresponding to the selected contents-related information item.

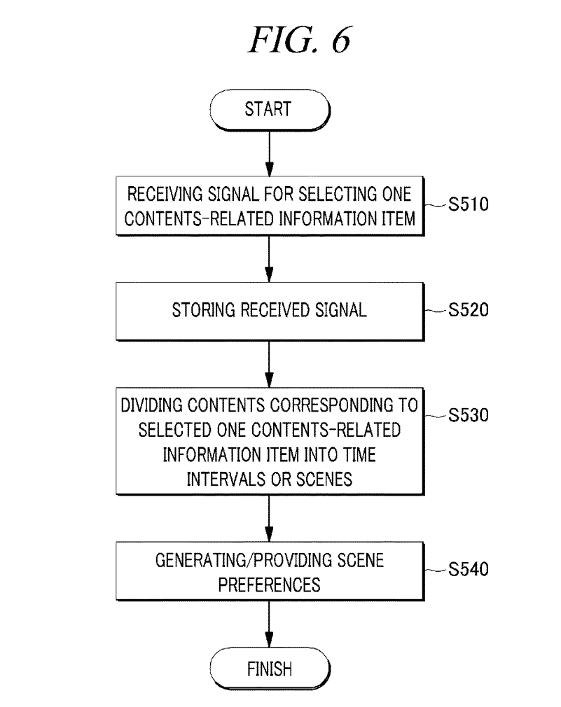

FIG. 6 is a flow chart illustrating a scene preferences generating method according to an exemplary embodiment.

In operation S510, the contents information management server receives from the user device a signal for selecting one contents-related information item from among at least one contents-related information. That is, during the reproduction of the contents, the user device may request information associated with a scene for which contents-related information is requested by the user, from the contents information management server.

The contents information management server may receive a reproduction time of the contents corresponding to the selected one of contents-related information item, together with the signal requesting a selection of one contents-related information item.

In operation S520, the contents information management server matches the contents, for which the contents-related information is requested in operation S510, with the reproduction time information to store the requested information. That is, the contents information management server stores the received signal for selecting one contents-related information item.

In operation S530, total reproduction time of the contents, for which the contents-related information item is requested, is divided into a plurality of time intervals or a plurality of scenes, to count the number of received signals. In other words, one content is divided into predetermined time intervals or scenes to identify how many requests for the selected one contents-related information item have been made.

In operation S540, scene preferences for a plurality of time intervals or a plurality of scenes of the contents is generated by using the number of received signals counted in operation S530. The generated scene preferences are provided to the contents information management server or the user.

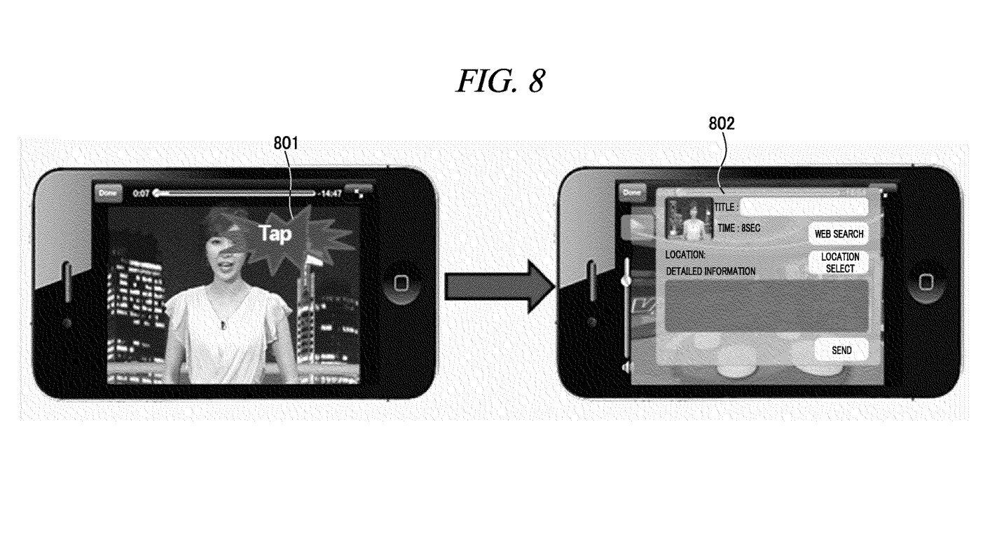

If contents-related information is provided in a form other than a list, such as for example shown in FIG. 8, the user requesting the contents-related information may be provided only the requested contents-related information corresponding to a scene currently displayed on a screen of the user device. In this case, there is no need to select one contents-related information item among at least one contents-related information, so that the scene preferences are generated by counting the number of requesting contents-related information from multiple user devices.

By using the scene preferences, the contents information management server or the user may generate and register contents-related information or input scene information for a time interval or a scene having a high preference.

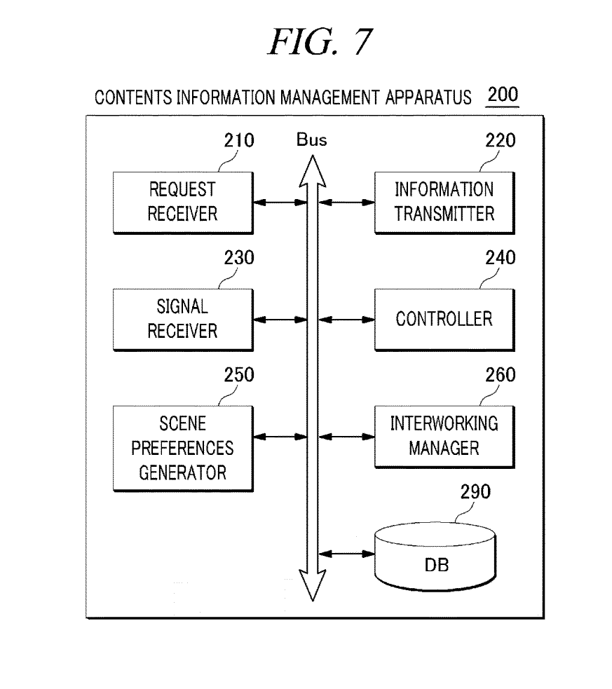

FIG. 7 is a block diagram illustrating a contents information management apparatus according to an exemplary embodiment.

The contents information management apparatus 200 according to an exemplary embodiment may include a request receiver 210, an information transmitter 220, a signal receiver 230, a controller 240, a scene preferences generator 250, an interworking manager 260, an information manager (not illustrated) and a database (DB) 290.

The request receiver 210 receives a request for providing contents-related information from a user device together with identification information of the contents.

Further, the request receiver 210 receives, from the user device, scene information input by the user. As aforementioned, the user may input scene information about a certain scene while being provided with contents using the user device.

The request receiver 210 may receive, from the user device, scene information input by the user with regard to a certain reproduction time of the contents together with the certain reproduction time information.

The information transmitter 220 searches, in response to the request received by the request receiver 210, for the requested contents-related information by using the received identification information of the contents via the information manager (not illustrated), and transmits the found result including at least one contents-related information item to the user device. The information transmitter 220 transmits reproduction time information matched with each of the found contents-related information together with the at least one contents-related information.

The information manager (not illustrated) receives a request for contents-related information from the information transmitter 220, and provides the at least one requested contents-related information, e.g., meta data of the contents, to the information transmitter 220.

Further, when receiving a signal for selecting one contents-related information item by the signal receiver 230, the information transmitter 220 transmits reproduction time information corresponding to the selected contents-related information item to the user device via a service providing server together with the identification information of the contents, and the transmitted reproduction time information may be found via the information manager (not illustrated).

The transmitted reproduction time information allows the user device to reproduce the contents from a time point indicated by the reproduction time information provided from the service providing server.

The signal receiver 230 receives the signal for selecting one contents-related information item from among the at least one contents-related information.

The controller 240 stores the scene information received by the request receiver 210 as tag information of the contents in the database 290 while matching the scene information with reproduction time information of the corresponding contents.

The controller 240 registers the scene information associated with the contents as contents-related information if the scene information meets a predetermined condition. The scene information including identification information of the contents and reproduction time information of the contents is received from the user device by the request receiver 210.

The scene preferences generator 250 generates a scene preference for the contents for each reproduction time interval or each scene of the contents based on the number of signals for selecting one contents-related information item received from multiple user devices.

In response to a contents reproduction request received from a first user device to reproduce the contents using a second user device, the interworking manager 260 requests that a service providing server provides contents to the second user device. The interworking manager 260 may provide reproduction time information together with the request for providing the contents to enable the corresponding contents to be reproduced from a certain reproduction time in the second user device.

The interworking manager 260 may acquire information about the second user device and information about the service providing server to request that the service providing server provide contents to the second user device.

FIG. 8 is a view illustrating a reproduction screen displaying contents-related information according to an exemplary embodiment.

As illustrated in FIG. 8, in an exemplary embodiment, the user may request 801 contents-related information during a reproduction of the contents in the user device, and then the user device may activate a layer 802 for providing contents-related information on the screen of the user device. The contents-related information providing layer may be overlaid with a previous contents reproduction screen, as shown in FIG. 8.

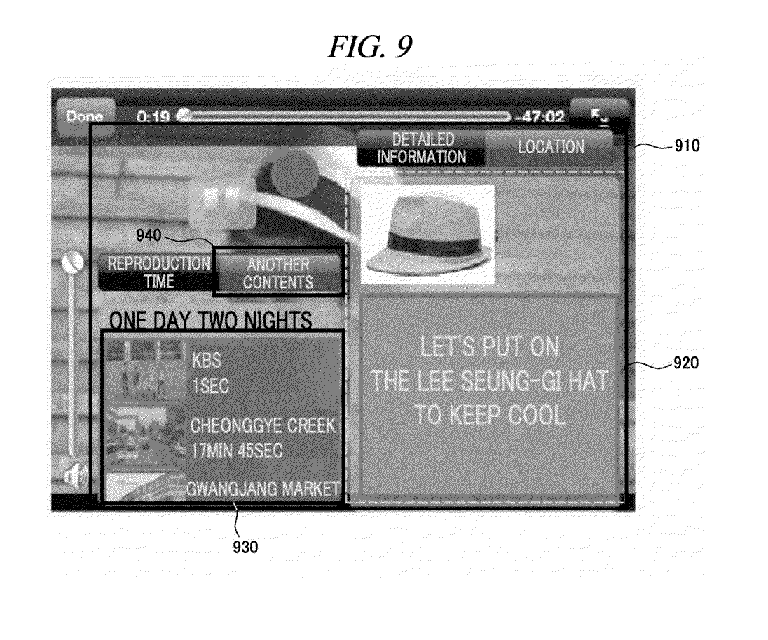

As illustrated in FIG. 9, during the reproduction of the contents in the user device, the user touch a user device screen 910 to activate the layer 920 for providing contents-related information. The activated layer 920 includes at least one contents-related information provided in a list form 930 and a “another contents” button 940. The user may select one contents-related information item by considering thumbnail images to watch the scene corresponding to the selected contents-related information. The user may select the “another contents” button 940 to watch another contents corresponding to the contents being reproduced or a scene being reproduced.

Exemplary embodiments may be embodied in a transitory or a non-transitory storage medium which includes instruction codes which are executable by a computer or a processor, such as a program module which is executable by the computer or processor. A data structure according to exemplary embodiments may be stored in the storage medium and executable by the computer or processor. A computer readable medium may be any usable medium which can be accessed by the computer and includes all volatile and/or non-volatile and removable and/or non-removable media. Further, the computer readable medium may include any or all computer storage and communication media. The computer storage medium may include any or all volatile/non-volatile and removable/non-removable media embodied by a certain method or technology for storing information such as, for example, computer readable instruction code, a data structure, a program module, or other data. The communication medium may include the computer readable instruction code, the data structure, the program module, or other data of a modulated data signal such as a carrier wave, or other transmission mechanism, and includes information transmission mediums.

The above description of exemplary embodiments is provided for the purpose of illustration, and it will be understood by those skilled in the art that various changes and modifications may be made without changing a technical conception and/or any essential features of the exemplary embodiments. Thus, above-described exemplary embodiments are exemplary in all aspects, and do not limit the present disclosure. For example, each component described to be of a single type can be implemented in a distributed manner. Likewise, components described to be distributed can be implemented in a combined manner.

The scope of the present inventive concept is defined by the following claims and their equivalents rather than by the detailed description of exemplary embodiments. It shall be understood that all modifications and embodiments conceived from the meaning and scope of the claims and their equivalents are included in the scope of the present inventive concept.

What is claimed is:

1. A method of providing content-related information comprising:
requesting contents-related information from a contents information management server;
receiving at least one contents-related information from the contents information management server;
displaying the at least one contents-related information;
receiving a user selection of one contents-related information item from among the at least one contents-related information; and
reproducing contents from a reproduction time corresponding to the selected contents-related information item.

2. The method of claim 1, wherein the requesting contents-related information is performed during a reproduction of the contents.

3. The method of claim 2, wherein the contents-related information is overlaid on a reproduction screen in which the contents are reproduced.

4. The method of claim 1, further comprising:
receiving scene information using a user interface during the reproduction of the contents; and
transmitting, to the contents information management server, the received scene information, identification information of the contents, and reproduction time information of the contents.

5. The method of claim 4, wherein the user interface is overlaid on a reproduction screen in which the contents are reproduced.

6. A method of transmitting contents-related information, the method comprising:
receiving a request, from a user device, for providing the contents-related information which is information related to contents being reproducing by the user device;
transmitting, in response to the request, at least one contents-related information to the user device;
receiving a signal for selecting one contents-related information item from among the at least one contents-related information; and
transmitting, to a service providing server, reproduction time information corresponding to the selected contents-related information item,
wherein reproduction time information for reproducing the contents by the user device from a time point indicated by the reproduction time information, is provided from the service providing server, and is obtained based on the transmitted reproduction time information.

7. The method of claim 6, further comprising:
receiving, from the user device, a request for registering scene information comprising identification information of the contents and reproduction time information of the contents;
determining if the receive scene information satisfies a predetermined criteria; and
generating new contents-related information by registering the scene information associated with the contents if the determining yields that the scene information satisfies the predetermined criteria.

8. The method of claim 6, further comprising:
counting a number of signals for selecting said one contents-related information item received from a plurality of user devices; and
generating scene preferences for the contents based on the counting.

9. The method of claim 8, further comprising dividing total reproduction time of the contents into a plurality of time intervals to determine a time interval for the reproduction time information, wherein the determined reproduction time information is at least one time interval from among the plurality of time intervals.

10. The method of claim 7, wherein the scene information comprises location information of a location displayed in a scene that is reproduced in the contents.

11. The method of claim 10, further comprising:
receiving, from the user device, the location information; and
transmitting, to the user device, contents-related information corresponding to the received location information.

12. A contents information management apparatus comprising:
a request receiver configured to receive a request from a user device for providing contents-related information, which is information related to contents being reproduced by the user device;
an information transmitter configured to transmit to the user device, in response to the request, at least one contents-related information; and
a signal receiver configured to receive a signal for selecting one contents-related information item from among the at least one contents-related information,
wherein the information transmitter is further configured to transmit reproduction time information corresponding to the selected contents-related information to a service providing server, and
wherein reproduction time information for reproducing the contents by the user device from a time point indicated by the reproduction time information, is provided from the service providing server and is obtained based on the transmitted reproduction time information.

13. The server of claim 12, further comprising:
a controller configured to determine if scene information received from a user device satisfies a predetermined criteria and configured to generate new content-related information by registering the received scene information as being associated with the contents if the determining yield that the scene information satisfies the predetermined criteria,
wherein the scene information comprises identification information of the contents and reproduction time information of the contents received from the user device by the request receiver.

14. The server of claim 12, further comprising:
a scene preferences generator configured to generate scene preferences for the contents based on a number of signals for selecting the one contents-related information item received from a plurality of user devices.

15. The method of claim 1, wherein a mobile device performs the requesting and wherein the reproducing of the contents is performed on a display apparatus connected to a set-top box.

16. The method of claim 1, wherein the content-related information comprises multimedia data related to the reproduced contents and additional advertisement contents related to the reproduced contents.

17. The method of claim 16, wherein the content-related information is provided by an Internet Protocol Television server.

18. The method of claim 1, wherein the requesting is performed by a user device connected to a display apparatus that reproduces the contents.

19. The method of claim 1, further comprising: requesting a generation of new content-related information item by receiving user input of selecting a scene in the reproduced content, by receiving user input of additional detailed information corresponding to the selected scene, and transmitting the selected scene and the input additional detailed information to the contents information management server.

20. The method of claim 1, wherein the user input of the additional detailed information is provided on a user interface that is overlaid on a reproduction screen in which the contents are reproduced by the user device.
